(19) United States
(12) Patent Application Publication
(10) Pub. No.: US 2008/0257927 A1
(43) Pub. Date: Oct. 23, 2008

(54) STORAGE SYSTEM FOR A VEHICLE

(75) Inventor: Lisa J. Feick, MARYSVILLE, OH (US)

Correspondence Address: ELEY LAW FIRM CO., 7870 OLENTANGY RIVER RD, SUITE 311, COLUMBUS, OH, 43235, US

(73) Assignee: HONDA MOTOR CO., LTD., TOKYO (JP)

(21) Appl. No.: 11/738,447

(22) Filed: Apr. 20, 2007

(51) Int. Cl. B60R 5/00

(52) U.S. Cl. 224/539

(57) ABSTRACT

A storage system for a vehicle. An insert of the storage system is configured to receive at least one food container of a given type. A cavity disposed in a floor of the vehicle is sized and shaped to receive the insert. A generally planar cover is configured to engage the floor to close off the cavity. The insert, cavity and cover cooperate to limit movement of the food container while being transported in the vehicle.

### FIELD

The present invention relates generally to storage systems, in particular to a storage system for transporting food containers.

### BACKGROUND

Transporting containers of food in vehicles is an everyday occurrence. A common example is transporting a covered dish to a social gathering such as a barbeque. The dishes and crockery used to prepare and store food are typically not designed with such transport in mind. As a result, cookware placed on the seat or floor of a moving vehicle tends to tip or spill when the vehicle makes a turn or a sudden start or stop.

An alternative means of transporting a food container by vehicle is for a person to hold the food container, using oven mitts or the like if the container is hot, on his or her lap, or to place the food container on the floor of the vehicle and prevent the food container from lateral movement with his or her feet or hands. This can be considerably burdensome, especially if the distance to be traveled is long. Moreover, holding the food container on the lap of the person may result in injury to the person if the food in the container is hot and spillage results.

Placing a food container on the floor of a vehicle has the added disadvantage of consuming space in the vehicle that would otherwise be used by passengers' feet. Consequently, the passengers are obliged to keep their feet and legs clear of the containers, causing discomfort if the distance to be traveled is long. Likewise, placing a food container on the floor of a vehicle can raise sanitation concerns and consumes space that could otherwise be used to carry cargo.

In view of the foregoing, it has been proposed to provide various types of carriers for dishes such as heated casseroles and the like to facilitate their transport from the place in which the food is prepared to a serving area. Examples of prior art carriers are disclosed in U.S. Pat. No. 6,375,134 to Goldschmidt et al. and U.S. Pat. No. 4,989,846 to Quinn. While such carriers reduce the risk of upsetting a food container during transport in a vehicle, the problems of consuming passenger and cargo space remain unsolved. There is a need for a way to transport a food container in a vehicle with reduced risk of spillage, and without consuming cabin space in the vehicle.

### SUMMARY

A storage compartment for a vehicle is disclosed according to an embodiment to the present invention. The storage compartment includes a cavity that extends below the floor of the vehicle. A removable, reversible insert adaptable to hold several types of food containers fits into the storage compartment. The cavity is sized and shaped to generally correspond to the shape of the insert, thereby preventing a food container stored therein from sliding or tipping. A cover closes off the storage compartment, allowing the floor of the vehicle to be utilized for other purposes such as cargo and passenger space. The cover also limits vertical movement of the insert, thereby preventing the food container from upsetting when the vehicle travels over uneven terrain. Any or all of the cavity, insert and cover may include thermal insulation to keep food stored therein hot or cold.

An aspect of the invention is a storage system for a vehicle. An insert of the storage system is configured to receive at least one food container of a given type. A cavity disposed in a floor of the vehicle is sized and shaped to receive the insert. A generally planar cover is configured to engage the floor to close off the cavity. The insert, cavity and cover cooperate to limit movement of the food container while being transported in the vehicle.

Another aspect of the present invention is an alternate embodiment of the storage system for a vehicle. The system comprises an insert configured to receive a plurality of types of food containers. A cavity disposed in a floor of the vehicle is sized and shaped to receive the insert. A detachable, generally planar cover having a grip is configured to engage and fit generally flush with the floor to close off the cavity. A latch releasably secures the cover to the floor. The insert, cavity and cover cooperate to limit movement of the food container while being transported in the vehicle.

Another aspect of the present invention is another alternate embodiment of the storage system for a vehicle. The system comprises an insert configured to receive a plurality of types of food containers. A cavity disposed in a floor of the vehicle is sized and shaped to receive the insert. A generally planar cover having a grip is configured to engage the floor to close off the cavity, the cover being hingedly coupled to the floor of the vehicle. A latch selectably secures the cover to the floor. The insert, cavity and cover cooperate to limit movement of the food container while being transported in the vehicle.

### BRIEF DESCRIPTION OF THE DRAWINGS

Further features of the inventive embodiments will become apparent to those skilled in the art to which the embodiments relate from reading the specification and claims with reference to the accompanying drawings, in which:

FIG. 1 is an elevational view showing the general arrangement of a storage system for a vehicle according to an embodiment of the present invention;

FIG. 2 shows a first orientation of an insert of a storage system for a vehicle according to an embodiment of the present invention;

FIG. 3 shows a second orientation of the insert of FIG. 2;

FIG. 4 is a view in section of the insert of FIG. 2;

FIG. 5 shows a cover of a storage system for a vehicle according to an embodiment of the present invention;

FIG. 6 is an elevational view showing the general arrangement of a storage system for a vehicle according to an alternate embodiment of the present invention;

FIG. 7 shows the general arrangement of a storage system for a vehicle according to another embodiment of the present invention; and

FIG. 8 shows the general arrangement of a storage system for a vehicle according to yet another embodiment of the present invention.

### DETAILED DESCRIPTION

In the discussion that follows, like reference numerals are used in the various figures to describe elements having like structure and function.

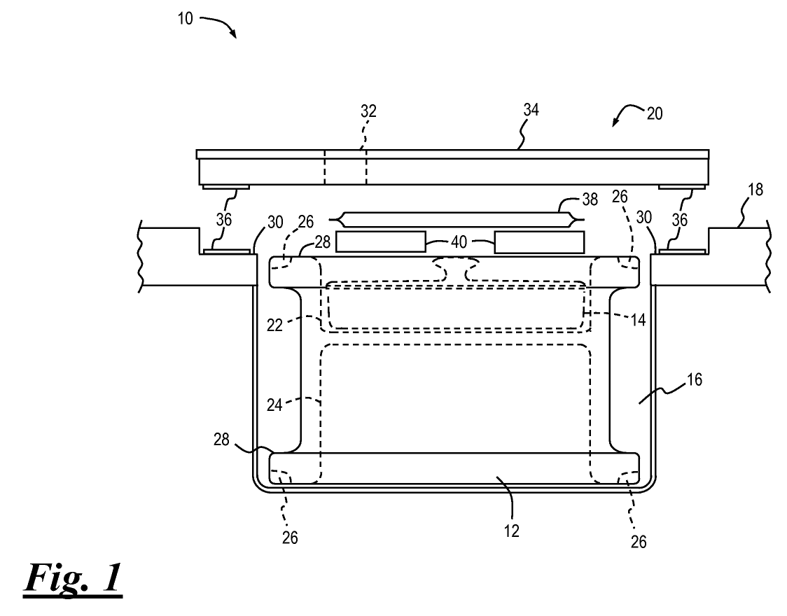

The general arrangement of a storage system 10 for a vehicle is shown in FIG. 1 according to an embodiment of the present invention. Storage system 10 comprises an insert 12 configured to receive at least one food container 14. The insert fits into a cavity 16 disposed in a floor 18 of the vehicle. A cover 20 closes off cavity 16. Insert 12, cavity 16 and cover 20 cooperate to limit movement of food container 14 while being transported in the vehicle, thereby deterring spillage of the food container during transport.

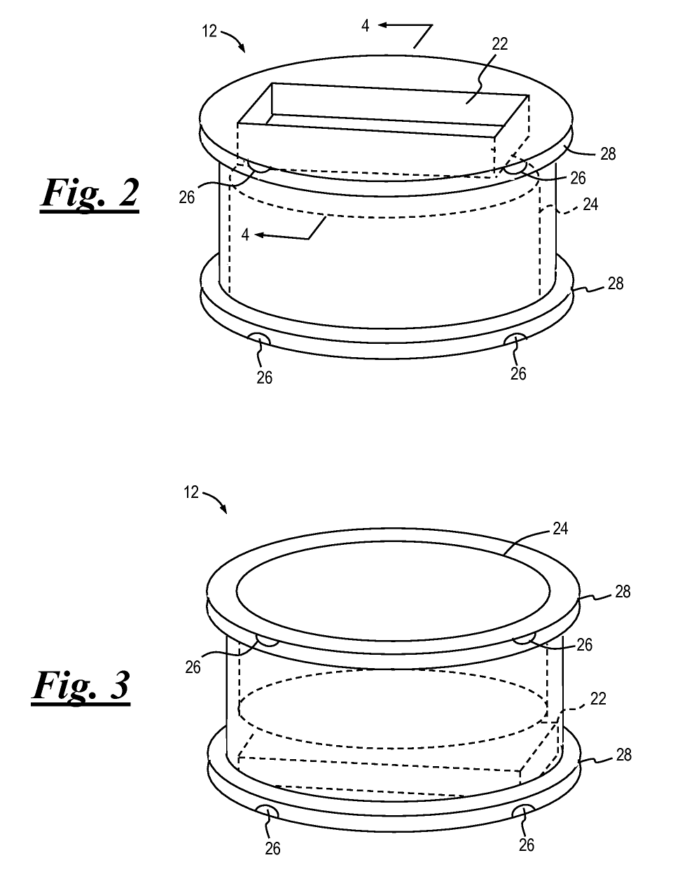

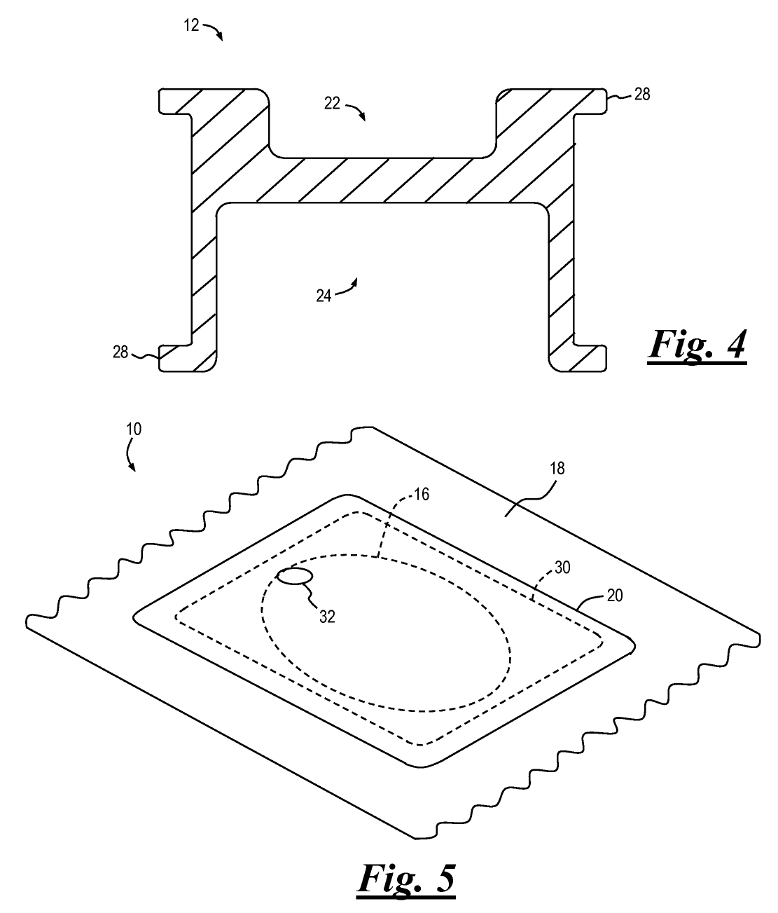

With reference to FIGS. 1, 2, 3 and 4 together, insert 12 is sized and shaped to receive at least one food container 14. In the embodiment of FIGS. 1-4 insert 12 is reversible in its orientation and is configured to receive food containers 14 having a range of sizes, shapes and heights. Accordingly, insert 12 includes a first receptacle 22 formed into a first end of the insert. As an example, first receptacle 22 may be generally rectangularly-shaped and of a depth to receive and retain a first type of food container 14. Examples of food containers received by receptacle 22 may include, without limitation, baking dishes, tins and shallow storage containers. A second, opposing end of insert 12 may include a second receptacle 24. In one embodiment second receptacle 24 may be generally oval-shaped and of a depth to receive and retain a second type of food container 14. Non-limiting examples of food containers 14 received by receptacle 24 may include casserole dishes, slow-cookers, tins and cylindrical or oval storage containers. The foregoing descriptions of receptacles 22, 24 are just two of many sizes and shapes that may be selected, and are not intended to be limiting. Receptacles 22, 24 may be varied in size and shape as desired to accommodate any type (i.e., size, shape and height) of food container now known or later invented.

Insert 12 may be made from any type of material suitable for use with system 10 and the expected environment including, without limitation, metal, plastic, fiberboard and composites. In addition, insert 12 may be formed in any conventional manner including, but not limited to, casting, machining, forming, molding and stamping. Furthermore, insert 12 may be finished in any conventional manner, such as painting, coating, plating, molded-in colors and decorative features, or may be left unfinished.

In some embodiments of the present invention insert 12 may include a plurality of detents 26, as shown in FIGS. 1, 2 and 3. Detents 26 allow a user to gain purchase on an edge of the portion of insert 12 that is in contact with the bottom of cavity 16 (FIG. 1), providing easy removal of the insert from the cavity. In other embodiments an upwardly-oriented lip 28 of insert 12 may be grasped by the user to install and remove the insert from cavity 16.

Insert 12 may further be made from or include a thermally insulative material to aid in maintaining the temperature of food container 14. Thermally insulative materials include, without limitation, foam, fibrous, fabric and plastic insulation.

Food container 14 may be any conventional type of container suitably sized and shaped for receptacles 22, 24 of insert 12 including, without limitation, baking dishes, casserole dishes, tins, storage containers, pans and slow-cooker crocks. Food container 14 may be made from metal, plastic, porcelain, glass or any combination thereof.

Cavity 16 may be formed in any convenient portion of floor 18 of a vehicle. Examples include, without limitation, forward of the front seats, forward of the rear seats, in a load floor, and in a trunk. Cavity 16 may be formed integral with floor 18 using formed metal, or may be made separately and joined to the floor with adhesive, welding or fasteners such as screws and rivets. Cavity 16 is preferably made of a unitary piece or material, or from components arranged to shield insert 12 from exposure to the elements.

Cavity 18 may be made from any type of material suitable for use with system 10 and the expected environment including, without limitation, metal, plastic, fiberboard and composites. In addition, cavity 18 may be formed in any conventional manner including, but not limited to, casting, machining, forming, molding, drawing and stamping. Furthermore, cavity 18 may be finished in any conventional manner, such as painting, coating or plating, or may be left unfinished. Cavity 18 may further be made from or include a thermally insulative material to aid in maintaining the temperature of food container 14. Thermally insulative materials include, without limitation, foam, fibrous, fabric and plastic insulation.

Cover 20 may be sized and shaped to fit onto a ledge 30 of floor 18, as shown in FIG. 1, such that the cover fits generally flush with the floor and is supported by the ledge. Cover 20 may further include a grip 32 such as an aperture through which a user may extend a finger to pull the cover upwardly. In some embodiments grip 32 may comprise a handle, tab or lever operable by a user to pull the cover upwardly.

Cover 20 may be made from any type of material suitable for use with system 10 and the expected environment including, without limitation, metal, plastic, fiberboard and composites. In addition, cover 20 may be formed in any conventional manner including, but not limited to, casting, machining, forming, molding, drawing and stamping. Furthermore, cover 20 may be finished in any conventional manner, such as painting, coating or plating, or may be left unfinished. In some embodiments cover 20 may include a decorative covering 34 such as carpeting, which may match or contrast with carpeting installed over floor 18. Cover 20 may further be made from or include a thermally insulative material to aid in maintaining the temperature of food container 14 stored in cavity 16. Thermally insulative materials include, without limitation, foam, fibrous, fabric and plastic insulation.

Cover 20 may be generally planar and rest upon ledge 30, as shown in FIGS. 1 and 5. In this embodiment cover 20 is removed by pulling upwardly using grip 32, causing the cover to detach from ledge 30. A user sets cover 20 aside while gaining access to cavity 16, then replaces the cover onto ledge 30 when finished. In some embodiments cover 20 and ledge 30 may include a latch comprising one or more fasteners 36 to selectably secure the cover to the ledge and deter inadvertent dislodging of the cover during transport. Fasteners include, without limitation, hook-and-loop, snaps and tabs. Alternatively, an interference fit may be used between cover 20 and ledge 30 to hold the cover in place.

In use, cover 20 is removed in the manner detailed above. Insert 12 is removed from cavity 16 and oriented such that the receptacle 22, 24 for a selected food container 14 is facing generally upwardly. The food container 14 is placed into the selected receptacle 22, 24. The assembly of insert 12 and food container 14 is then placed into cavity 16 with the food container facing generally upwardly. Cover 20 is placed onto ledge 30, closing off cavity 16. After the vehicle reaches its destination cover 20 and insert 12 are removed. Insert 12 may be used as a carrier to transport food container 14 from the vehicle, particularly if the food container is hot. Food container 14 may then be removed from insert 12 for use.

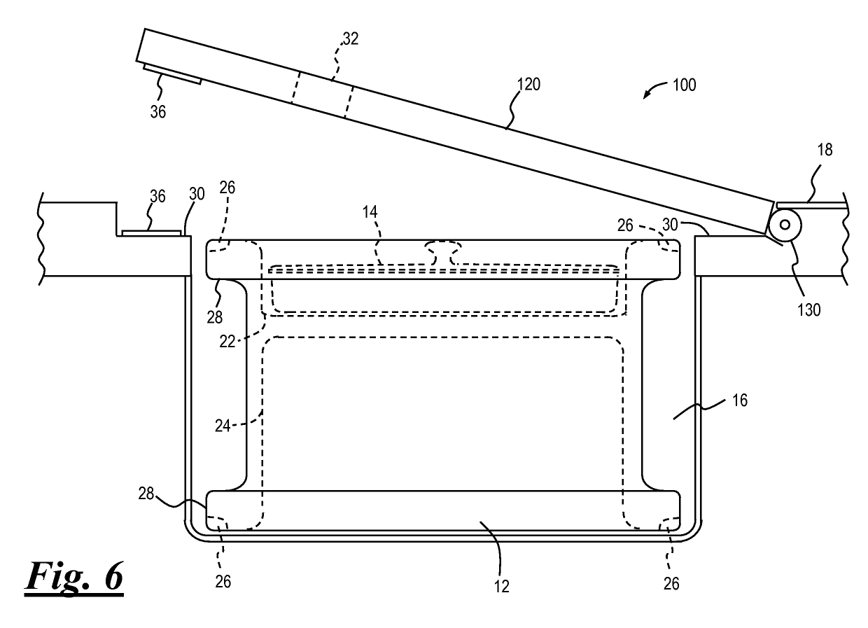

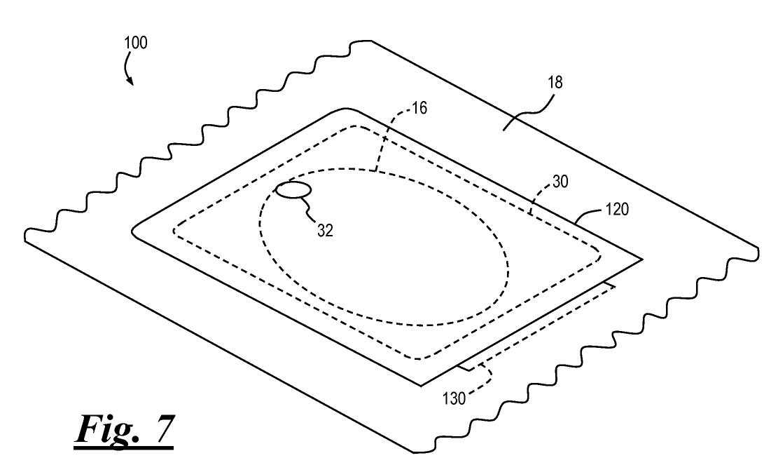

A storage system 100 according to an alternate embodiment of the present invention is shown in FIGS. 6 and 7. In this embodiment a cover 120 is pivotally attached to floor 18 by one or more hinges 130. Cover 120 is operated by pulling upwardly on a grip 32, causing the cover to pivot about hinge 130 and providing access to cavity 16. Cover 120 is likewise pivoted downwardly about hinge 130 to rest upon ledge 30 when cavity 16 is to be closed off. Storage system 100 is otherwise similar to storage system 10 in structure and operation and thus will not be reiterated here.

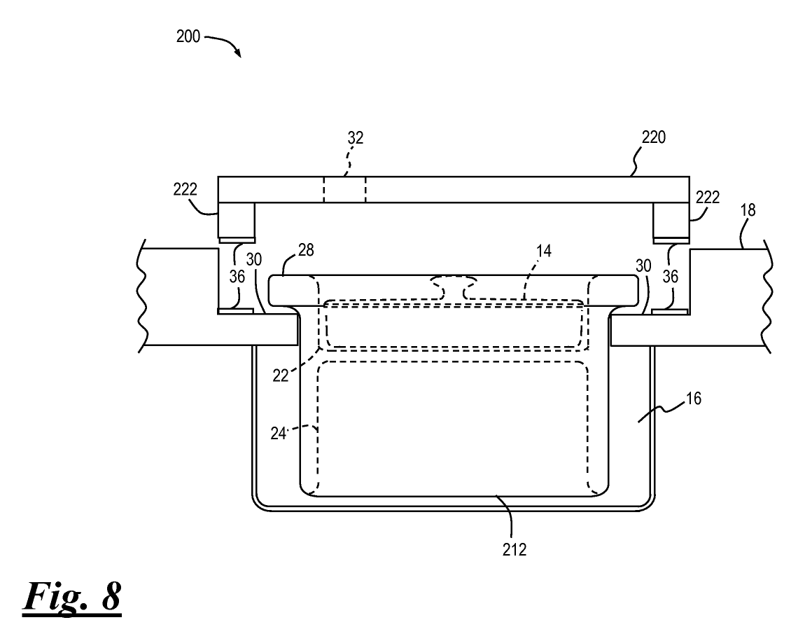

A storage system 200 according to another alternate embodiment of the present invention is shown in FIG. 8. In this embodiment a lip 28 of an insert 212 rests upon a ledge 30. A cover 220, which may be detachable in the same manner as cover 20 (FIG. 1) or hinged in the same manner as cover 120 (FIG. 6) rests atop lip 28. Cover 220 may be flush with floor 18, or may extend above the floor. In some embodiments cover 220 may be sized and shaped to rest upon floor 18, and may optionally include an extension portion 222 extending downwardly proximate lip 28 of insert 212. Cover 220 may be secured with a latch, such as fasteners 36. Storage system 200 is otherwise similar to storage systems 10, 100 in structure and operation and thus will not be reiterated here.

In some embodiments of the present invention storage systems 10, 100, 200 may further include a conventional reusable hot or cold gel pack 38, as shown generally in FIG. 1. The hot or cold gel pack 38 may be heated in a microwave or frozen in a freezer, then placed proximate food container 14 to keep the container hot or cold as desired. Hot and cold packs are commercially available from such sources as Roshgo Corporation and Pyrex®, among others.

In some embodiments of the present invention storage systems 10, 100, 200 may further include one or more removable spacers 40, as shown generally in FIG. 1. Spacers 40 may be inserted between food container 14 and inserts 12, 212 to help prevent the food container from moving with respect to the insert during transport. Similarly, spacers 40 may be used between food container 14 and cover 20 to help prevent a lid of the food container from dislodging during transport. Likewise, spacers 40 may be used to limit movement between inserts 12, 212 and cavity 16 during transport. Spacers 40 may rigid, semi-rigid or resilient and may be made from any material suitable for use with storage systems 10, 100, 200 and the expected environment including, without limitation, foam, rubber and plastic. Spacers 40 may also include or comprise thermally insulative materials such as foam, fibrous, fabric and plastic insulation to aid in maintaining the temperature of food container 14.

While this invention has been shown and described with respect to a detailed embodiment thereof, it will be understood by those skilled in the art that changes in form and detail thereof may be made without departing from the scope of the claims of the invention.

What is claimed is:

1. A storage system for a vehicle, comprising:
an insert configured to receive at least one food container of a given type;
a cavity disposed in a floor of the vehicle, the cavity being sized and shaped to receive the insert; and
a generally planar cover configured to engage the floor to close off the cavity,
wherein the insert, cavity and cover cooperate to limit movement of the food container while being transported in the vehicle.

2. The storage system of claim 1 wherein the insert is configured to receive a plurality of types of food containers.

3. The storage system of claim 1 wherein the insert further comprises at least one detent.

4. The storage system of claim 1 wherein the insert further comprises a thermally insulative material.

5. The storage system of claim 1 wherein the insert further comprises at least one lip.

6. The storage system of claim 1 wherein the cavity further includes a thermally insulative material.

7. The storage system of claim 1 wherein the cavity is located at one of forward of the front seats, forward of the rear seats, in a load floor and in a trunk of the vehicle.

8. The storage system of claim 1 wherein the cover is detachable from the floor of the vehicle.

9. The storage system of claim 1 wherein the cover is hingedly coupled to the floor of the vehicle.

10. The storage system of claim 1 wherein the cover further includes a latch to selectably secure the cover to the floor.

11. The storage system of claim 10 wherein the latch is one of an interference fit, hook-and-loop fasteners, snap fasteners and tab fasteners.

12. The storage system of claim 1 wherein the cover further includes a grip.

13. The storage system of claim 12 wherein the grip is one of an aperture, handle, tab and lever.

14. The storage system of claim 1 wherein the floor further comprises a ledge configured to receive the cover.

15. The storage system of claim 14 wherein the cover fits generally flush with the floor.

16. The storage system of claim 1 wherein the cover further includes a decorative covering.

17. The storage system of claim 1 wherein the cover further includes a thermally insulative material on an inner surface.

18. The storage system of claim 1, further comprising a gel pack proximate the food container.

19. The storage system of claim 1, further comprising at least one spacer proximate at least one of the insert, the food container, the cover and the cavity.

20. A storage system for a vehicle, comprising:
an insert configured to receive a plurality of types of food containers;
a cavity disposed in a floor of the vehicle, the cavity being sized and shaped to receive the insert;
a detachable, generally planar cover having a grip and being configured to engage and fit generally flush with the floor to close off the cavity; and
a latch to releasably secure the cover to the floor,
wherein the insert, cavity and cover cooperate to limit movement of the food container while being transported in the vehicle.

21. A storage system for a vehicle, comprising:
an insert configured to receive a plurality of types of food containers;
a cavity disposed in a floor of the vehicle, the cavity being sized and shaped to receive the insert;
a generally planar cover having a grip and being configured to engage the floor to close off the cavity, the cover being hingedly coupled to the floor of the vehicle; and
a latch to selectably secure the cover to the floor,
wherein the insert, cavity and cover cooperate to limit movement of the food container while being transported in the vehicle.
